(19) United States
(12) Patent Application Publication
(10) Pub. No.: US 2025/0331494 A1
(43) Pub. Date: Oct. 30, 2025

(54) AUTOMATED ROBOTIC ARM ASSEMBLY AND SMART CAGE ASSEMBLY SYSTEM FOR VERTEBRATE ANIMAL CARE

(71) Applicant: Olden Labs, PBC., Allston, MA (US)

(72) Inventors: Michael Florea, Allston, MA (US); Pratomo Alimsijah, Palo Alto, CA (US); Michal Kaca, Pacifica, CA (US); Noah Weber, Mill Valley, CA (US)

(21) Appl. No.: 19/195,131

(22) Filed: Apr. 30, 2025

Related U.S. Application Data
(60) Provisional application No. 63/640,769, filed on Apr. 30, 2024.

(51) Int. Cl. A01K 1/03; B25J 5/04; B25J 9/02; B25J 9/16; B25J 11/00; B25J 15/04; B25J 19/02; B65G 1/137

(52) U.S. Cl. CPC A01K 1/031; B25J 5/04; B25J 9/026; B25J 9/1697; B25J 11/008; B25J 19/02; B65G 1/1371; B25J 15/04; B65G 2203/041; B65G 2203/046

(57) ABSTRACT

A robotic arm assembly and rack assembly that includes at least one computer system and software program designed to operate the robotic arm assembly. An operating assembly includes one or more actuators, controllers, and sensors. A robotic arm assembly is operationally and movably coupled to a rack assembly. A rail assembly is designed to guide the robotic arm assembly along coordinates of a three-dimensional space containing the rack assembly. A center axis stems from a port assembly wherein the tool assembly portion is designed to be directionally vectored within polar coordinates. The robotic arm assembly is designed to engage smart cage assemblies disposed on the rack assemblies from a programmed set of operations.

### CROSS-REFERENCE TO RELATED APPLICATIONS

This application claims priority to and the benefit of U.S. provisional application 63/640,769 titled ROBOTIC ARM ASSEMBLY SYSTEM filed on Apr. 30, 2024, which is incorporated herein by reference in its entirety.

### FIELD OF THE INVENTION

The present invention relates to an automated robotic arm assembly system integrated with smart cage assemblies for autonomous monitoring and maintenance of vertebrate animals in vivarium settings

### BACKGROUND

Mouse rearing in the vivarium settings has, for the most part, remained the same as in the early 1930s. While many vivariums now use automated water dispensing systems, in-cage delivery of purified air, and sometimes RFID-based cage cards for billing purposes, the bulk of the work is done in a traditional way. Mice are housed in shoe-box-sized cages inside rack assemblies, with cages labelled by hand and animals checked once daily by a team of animal technicians. Cages are changed manually based mostly on the subjective assessment of the technician of whether a cage has been overly soiled. Food is similarly manually replaced. Any issues are reported to resident veterinarians, who then perform more thorough health checks or treatments. For the most part, conventional healthcare results in directing the animal to euthanasia, as many conditions are discovered too late to be treatable or worth treating economically. Taken together, this is highly laborious, resulting in a need for a large workforce to maintain a sizable colony. Results in health conditions are often discovered too late for treatment, and deceased animals may be discovered too late to perform a cause of death necropsy.

In the context of aging experiments, a requirement for a large workforce results in a high cost of upkeep for aged animals over their lifetime. Currently, at the time of filing, a single 1.5-year-old aged C57BL6/J mouse (the most common and least expensive mouse model) costs approximately $370; the lifetime cost of a mouse over ˜2.5 years exceeds $500. This means that an average mouse aging study using 100 animals costs $50,000 on mouse upkeep alone, a figure prohibitively expensive for most academic labs and even many companies. Yet, compared to this, the “raw materials” cost that is required for mouse upkeep over its life (cost of food, water, and bedding) amounts to only ˜30 USD. That is, the difference between the current cost and the lowest possible cost of an aged animal is about 20×.

Therefore, there is a need in the market for an improved robotic system for rearing mice and other vertebrate animals.

### SUMMARY OF THE INVENTION

Disclosed is a robotic arm assembly and rack assembly that includes at least one computer system and software program designed to operate the robotic arm assembly. An operating assembly includes one or more actuators, controllers, and sensors. At least an upper arm portion of the robotic arm assembly is hingedly coupled to a lower arm portion by an elbow joint, a proximal portion of the lower arm portion is hingedly coupled to a wrist joint, a tool assembly is hingedly coupled to the wrist joint, and a distal portion of the upper arm portion is hingedly coupled to a shoulder joint. A base portion is hingedly coupled to the shoulder joint and hingedly coupled to a port assembly. The port assembly is movably coupled to a rail assembly operationally contiguous with the rack assembly. The rail assembly is designed to guide the robotic arm assembly along cartesian coordinates x, y, and z of a three-dimensional space containing the rack assembly. A center axis stems from the port assembly wherein the tool assembly portion is designed to be directionally vectored within polar coordinates r, θ, and z. The robotic arm assembly is designed to engage smart cage assemblies disposed on the rack assemblies from a programmed set of maintenance operations.

The robotic arm assembly's engagement with smart cage assemblies may be conditional upon receiving sensor data that said engagement will address. The robotic arm assembly's engagement with smart cage assemblies may be based on a schedule. The robotic arm assembly's tool assembly may be a gripper tool assembly. The robotic arm assembly's tool assembly may be interchangeable from a group including at least: a claw tool assembly, a gripper tool assembly, a dispenser tool assembly, and a rotational tool assembly. The robotic arm assembly may include at least one optical sensor disposed on the robotic arm assembly.

The robotic arm assembly may be at least partially operated manually by way of a user interface operationally coupled to the computer system. The robotic arm assembly may be designed to halt operations before the robotic arm assembly contacts a person.

The software program of the robotic arm assembly may be designed to learn patterns and make predictions autonomously. The robotic arm assembly software program may use data from which patterns are derived wherein the data includes data generated by sensors within the smart cage assemblies. Such patterns include, but are not limited to, animal travel and interaction patterns.

In some embodiments of the smart cage assembly system and method for housing and assaying multiple vertebrate animals, the robotic arm assembly is operationally coupled to move horizontally and vertically substantially along the entirety of the height and width of the rack assembly and is further designed to remove housing assemblies at least partly from the rack assembly.

The smart cage assembly and robotic arm assembly system may further contain an automated restraining, anesthetizing, injection, and blood collection system to perform injections and blood draws on vertebrate animals within the smart cage assembly system.

The robotic arm assembly and rack assembly having the rack assembly configured to house the plurality of smart cage assemblies, each smart cage assembly including an external sensor array with sensors for monitoring animal health. The robotic arm assembly is movably coupled to the rack assembly via the rail assembly, the robotic arm assembly including at least one computer and a software program configured to control the robotic arm assembly. The operating assembly comprises actuators, controllers, and a 3D vision system for detecting object positions.

The tool assembly is interchangeably equipped with at least one of the claw tool assembly, the gripper tool assembly, the dispenser tool assembly, or the rotational tool assembly, the tool assembly configured to engage the smart cage assemblies for automated maintenance tasks. The robotic arm assembly is configured to perform automated maintenance tasks, including cage exchanges, food and water replenishment, and cage enclosure cleaning, based on sensor data from the smart cage assemblies or a predefined schedule, and to connect smart cage assemblies via a mouse inlet port designed to transfer animals without direct robot or human contact.

In some embodiments, automated cage exchanges include that the robotic arm assembly is configured to remove a used smart cage assembly from the rack assembly, connect a clean smart cage assembly to the used smart cage assembly via the mouse inlet port, and use incentives to encourage animal movement to the clean smart cage assembly. The incentives may include at least one of placing food or water in the clean smart cage assembly or applying light, sound, or vibration to the used smart cage assembly. The robotic arm assembly and rack assembly may further include a 3D vision system having at least one of a stereo camera system, a structured light sensor, or a time-of-flight camera, configured to detect the size, shape, and 3D distance of objects within the rack assembly for precise engagement by the tool assembly.

The robotic arm assembly and rack assembly may include a force/torque sensor disposed on the tool assembly, the force/torque sensor configured to detect the level of force exerted during automated maintenance tasks, especially to prevent damage to the smart cage assemblies or objects. The robotic arm assembly and rack assembly may be configured to weigh food or water prior to replenishment by placing a food container or water bottle on a scale and recording the weight using an onboard camera or an electrically connected scale. The robotic arm assembly and rack assembly may further include a machine learning module of the software program configured to learn patterns from sensor data generated by the smart cage assemblies and predict maintenance needs autonomously. In the robotic arm assembly and rack assembly, the robotic arm assembly may be configured to move smart cage assemblies between the rack assembly and a pass-through window or a holding rack assembly for experimental or maintenance purposes, the movement being guided by the 3D vision system.

It is an object of the invention to significantly reduce the labor costs associated with rearing mice and other vertebrate animals in vivarium settings. It is further an object of the invention to enhance animal welfare by improving health monitoring and enabling early detection of health issues in vivarium animals. It is a third object of the invention to provide a scalable, safe, and biocontainment-compatible system for vivarium operations, allowing rapid deployment and operation in various environments while minimizing human intervention and contamination risks.

These and other objects, features, and advantages of the present invention will become readily apparent upon a review of the following detailed description of the invention, in view of the drawings and appended claims.

### BRIEF DESCRIPTION OF THE DRAWINGS

The nature and mode of the operation of the present invention will now be more fully described in the following detailed description of the invention taken with the accompanying drawing figures, in which:

FIG. 1 illustrates a representative robotic arm assembly and rack assembly;

FIG. 2 illustrates an operating system of the robotic arm assembly and rack assembly;

FIG. 3A illustrates the robotic arm assembly with a 3D vision system, including stereo camera system;

FIG. 3B illustrates the robotic arm assembly with an RFID system, showing RFID reader detecting RFID sensors;

FIG. 4A illustrates a representative biocontainment room with robotic arm assembly and rack assembly;

FIG. 4B illustrates a representative biocontainment room with robotic arm assembly and an autonomous ground vehicle;

FIG. 4C illustrates a ground vehicle side view;

FIG. 5A illustrates a connection between a smart cage and a port cage;

FIG. 5B illustrates door and one way valve with tunnel;

FIG. 6 illustrates tool assembly types each rotated downward and front wise;

FIG. 7 illustrates a 3d vision system;

FIG. 8 illustrates a representative robotic arm assembly and rack assembly smart cage exchange method;

FIG. 9A-9E illustrates steps of a smart cage exchange; and

FIG. 10A illustrates a smart cage with inlet port in internal cage top, connected to tunnel.

FIG. 10B illustrates a cross-sectional view of tunnel adapted for internal cage tops with one-way valve.

### DETAILED DESCRIPTION OF THE INVENTION

Following are detailed descriptions of various related concepts related to, and embodiments of, methods and apparatus according to the present disclosure. It should, however, be understood that this disclosure is not limited to the particular methodology, materials, and modifications described and, as such, may, of course, vary. It is also understood that the terminology used herein is for the purpose of describing particular aspects of the invention only and is not intended to limit the scope of the claims.

Furthermore, it should be appreciated that drawings are representative to illustrate the inventive concepts herein and may not be to scale. Also, like drawing numbers on different drawing views identify identical, or functionally similar, structural elements where there could appear some variations on exactness where exactness is not material to the inventive concept herein. For illustration, the type of head on a helically threaded connector could differ on like identified items when the importance is that the identified item is a helically threaded connector, and other items could be treated similarly. It is to be understood that the claims are not limited to the disclosed aspects.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

The most effective way to reduce the cost of an aged mouse is to reduce the manual labor required to rear it over its lifetime. This can be done by engineering two main capabilities: 1) automated mouse monitoring and 2) automated cage changes. The disclosed invention achieves these results through the use of smart cage assemblies and rack assemblies that include a robotic arm assembly. These rack assemblies and robotic arm assemblies will be housed in modular rooms, designed to be rapidly and scalably built in many environments.

The smart cage assembly has an array of sensors which are designed to monitor mice or other vertebrate animals. For an illustration of mouse monitoring, representative embodiments use monitoring cages and other cages such as track cages that may have varying sensor profiles but at least contain video track capacity. Using video track the mouse monitoring system can estimate the health of each mouse by monitoring a) activity, b) skin lesions and c) morphological abnormalities. Together, these three metrics can capture the vast majority of mouse health issues, such as ulcerative dermatitis, tumors, fighting, prolapses, or general decreases of health (read by decreased activity). These tasks can all be done from video data alone. Additionally, because daily checks are mission-critical and mandated by good vivarium practices, in order to prevent a short-staffing situation in the case the video monitoring system should malfunction, each cage can be equipped with an independent backup video system—a separate RPi computer system connected to a separate camera and power source. These sensors contribute to actions of the robotic arm assembly and rack assemblies where a condition for robotic arm assemblies to take a given action is typically that one or more sensors provided a reason for taking that action.

For illustration, if A is a random variable for possible health issues sensors might detect, a, where A=a for Σₐ, and B is a random variable for the possible actions of the robotic arm assemblies where B=b for Σ_{b}, then B=b|A=a for those observation x that are a condition for taking action y.

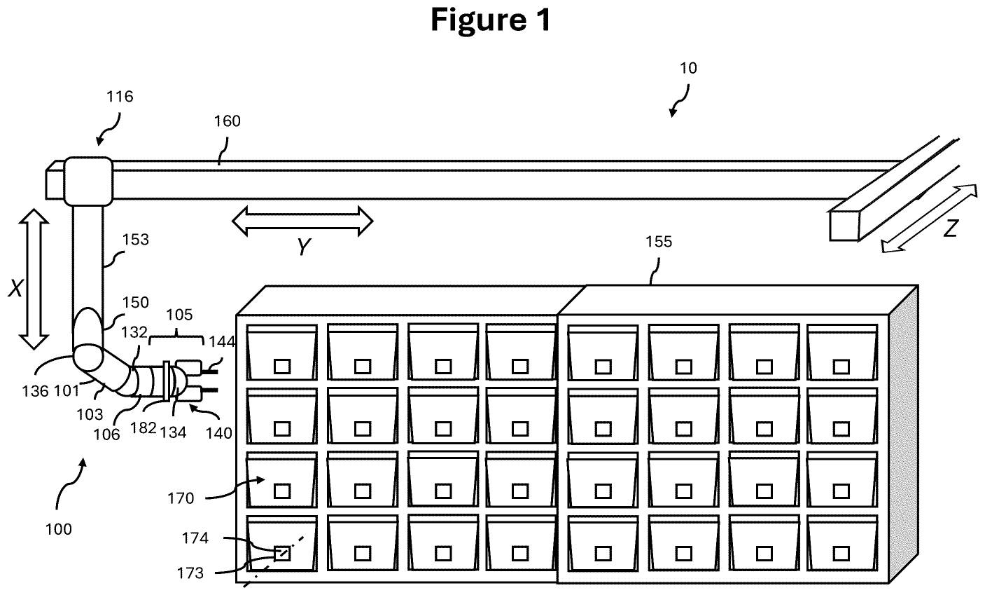

FIG. 1 illustrates an embodiment of robotic arm assembly and rack assembly 10 that includes robotic arm assembly 100 designed to automate smart cage assembly 170 change for a rack assembly 155 and rail assembly 160 where B, the action the robot takes is conditional on A, some need for caretaking mice such as, in the above illustration, might be triggered by a sensor reading, but might be other factors of greater or lesser predictability, to include routine actions such as periodic maintenance on a time interval or adding water when a water bottle has run dry. This embodiment illustrates numerous smart cage assemblies 170, but the invention, as disclosed, can operate with cages that lack such items as sensors. Smart cage 170 here is defined as a cage for rodents that does or could have sensors mounted in, on, or around it for measuring the cage's environment or animals within the cage.

FIG. 1 further illustrates an embodiment wherein robotic arm assembly and rack assembly 10, having rack assembly 155 configured to house a plurality of smart cage assemblies 170. Robotic arm assembly 100 includes a physical framework of robotic arm assembly 100 that provides support and defines its range of motion. It includes joints, links, and end-effectors tailored to specific applications, as will be detailed.

Robotic arm assembly 100 typically has six degrees of freedom and is programmed to move via x, y, and z axes on rails outfitted above rack assembly 155—rack assembly 155 containing smart cage assemblies 170—and then a separate, 3D polar coordinates set wherein robotic arm assembly 100 may be positioned around at least one axial point of robotic arm assembly 100 such as door 174 at with inlet port 173 or shoulder joint 136 where radius (r) is the distance from the origin to the point, angle (θ) is the angle formed by the line segment connecting given origin to the point and the positive x-axis, measured in a counterclockwise direction, and Z-axis (z) is the variable that represents the position of the point along the z-axis. Robotic arm assembly 100 may also be programmed to move via Cartesian coordinates, wherein joint positions and a given tool assembly 140, here illustrated gripper 144, can be used to calculate vectors, wherein the joints, which will be detailed, are positioned to bring the tool assembly 140 to the desired positions.

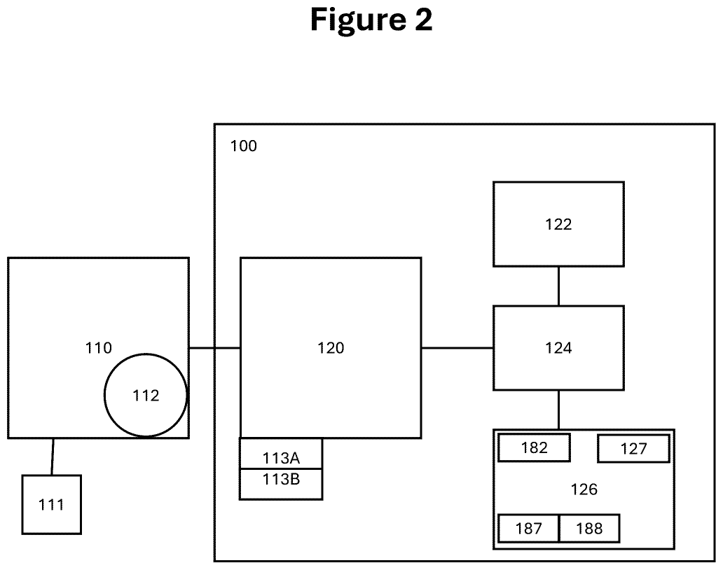

Embodiments of robotic arm and rack assembly 10 may use a spherical coordinate system to guide the robotic arm assembly 100 in engaging smart cage assemblies 170 on rack assembly 155, with the origin defined at port assembly 153, which is movably coupled to rail assembly 160. Tool assembly's 140 position is specified by three coordinates: radial distance (ρ), distance from port assembly 153 to tool assembly 140; polar angle (θ), measured from the vertical z-axis (aligned with the rack's height) to tool assembly's position, ranging from 0° (up) to 180° (down); and azimuthal angle (φ), measured in the horizontal xy-plane from a reference direction (e.g., the rack's width) to the tool assembly's projection, ranging from 0° to 360°-named references corresponding to numbered elements above. Port assembly 153 moves to discrete origin points along rail assembly 160 to cover rack assembly 155, and robotic arm assembly 100 adjusts (ρ, θ, φ) to reach specific cages 170, guided by the 3D vision system 182 for precise tasks like cage exchanges or food replenishment, while software program 112 maps, as introduced in FIG. 2, data from sensors 126 to these coordinates and controls joint angles (shoulder 136, elbow 132, wrist 134) to ensure accurate positioning and orientation, enabling efficient, contactless animal care without reliance on a Cartesian-polar hybrid system.

Embodiments of robotic arm and rack assembly 10 may use an articulated inverse kinematics (IK) approach to control the robotic arm assembly 100 for engaging smart cage assemblies 170 on rack assembly 155, by directly computing joint angles for shoulder joint 136, elbow joint 132, and wrist joint 134, along with the position of the port assembly 153 along the rail assembly 160, to achieve six degrees of freedom movement. Software program 112 in these embodiments uses IK solver to determine the joint angles (e.g., θ₁, θ₂, θ₃) and a linear rail position (s) required to position tool assembly 140 at a target location (e.g., a given smart cage 170), based on input from 3D vision system 182 that provides given cage's 170 position and orientation. Solver optimizes for constraints like joint 132, 134, 136 limits, singularity avoidance, and collision prevention, enabling precise tasks such as cage 170 exchanges, food replenishment, or connecting cages 170 via mouse inlet port 173, with real-time feedback from, illustrated in FIG. 2, force/torque sensors 186 adjusting angles dynamically, convertible to or from a Cartesian or polar coordinate system.

Embodiments of the robotic arm and rack assembly system 10 may use a cylindrical coordinate system to guide the robotic arm assembly 100 in engaging smart cage assemblies 170 on rack assembly 155, with the origin defined at port assembly 153, which is movably coupled to rail assembly 160. The tool assembly 140 position is specified by three coordinates: radial distance (ρ), horizontal distance from the port assembly's 153 vertical axis to the tool assembly 140; azimuthal angle (θ), measured in the horizontal xy-plane from a reference direction (e.g., the rack's 155 width) to the tool assembly's 140 projection, ranging from 0° to 360°; and height (z), vertical position along the rack 155 relative to the origin. Port assembly 153 moves to discrete origin points along rail assembly 155 to cover rack 155, and the arm adjusts (ρ, θ, z) to reach specific cages 170, 171, 172. Software program 112 maps coordinates and controls joint angles (shoulder 136, elbow 132, wrist 134) to ensure precise positioning and orientation for tasks such as cage 170 exchanges or food replenishment.

FIG. 1 further illustrates that at least an upper arm portion 103 of robotic arm assembly 100 is hingedly coupled to lower arm portion 106 by elbow joint 132, proximal portion of the lower arm portion 105 hingedly coupled to wrist joint 134, tool assembly 140 hingedly coupled to wrist joint 134, and distal portion of upper arm portion 101 hingedly coupled to shoulder joint 136.

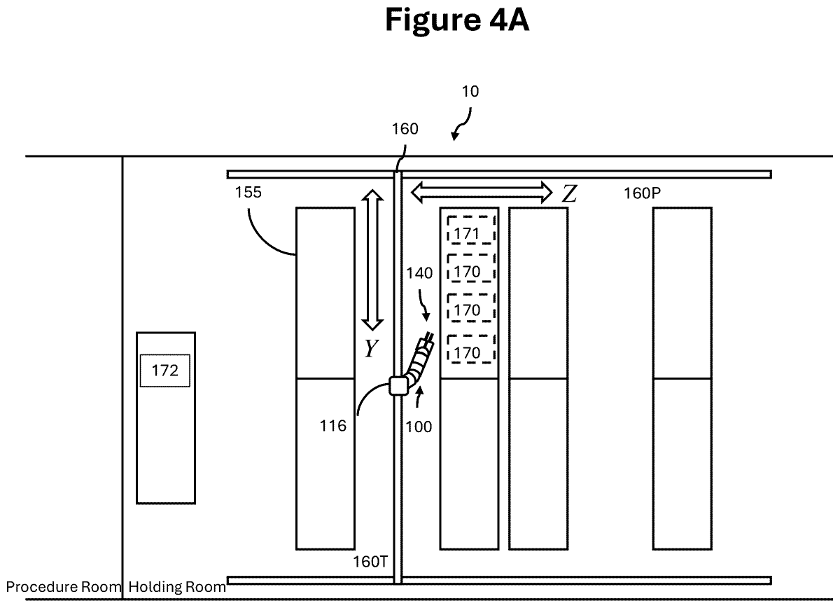

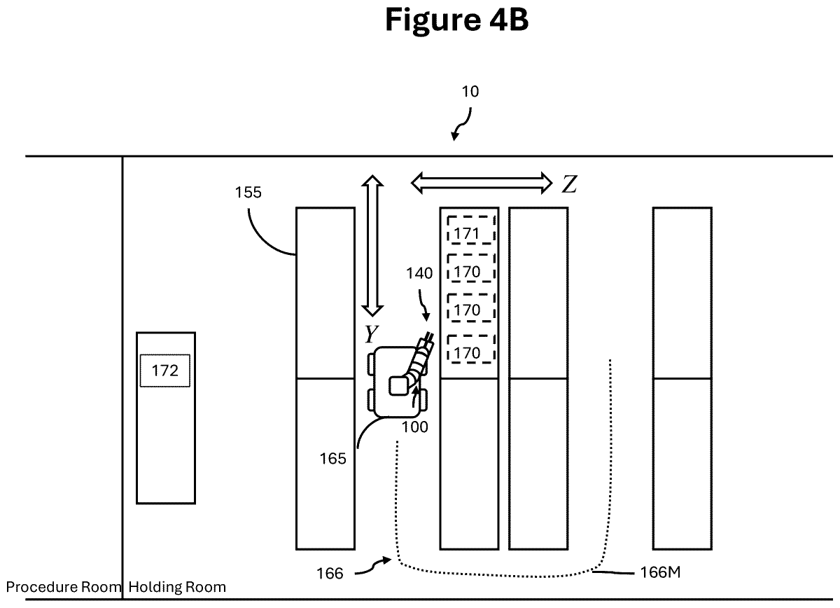

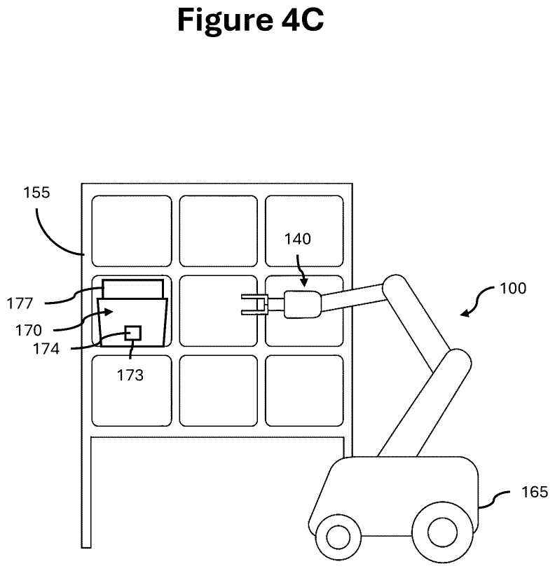

Base portion 150 is hingedly coupled to shoulder joint 136 and hingedly coupled to port assembly 153. Port assembly 153 is movably coupled to rail assembly 160, which is operationally contiguous with rack assembly 155. In such assemblies, robotic arm assembly 100 can travel along rail assembly 160 by gantry robot 116. Robotic arm assembly 100 movably accesses rack assembly 155 via movement along rail assembly 160. Rail assembly 160 is designed to guide robotic arm assembly 100 along Cartesian coordinates x, y, and z of a three-dimensional space containing rack assembly 155 wherein, as illustrated in FIG. 4A, transverse rail 160T can move along parallel rails 160P on illustrated Z directions and robotic arm assembly moves in illustrated Y directions along transverse rail 160T. Alternatively, fixed rails may be used where gantry robot 116 travels along all rails and turns corners. A center axis stems from door 174, wherein tool assembly 140 is designed to be directionally vectored within polar coordinates r, θ, and Φ. Robotic arm assembly 100 is designed to engage smart cage assemblies 170 disposed on rack assemblies 155 from a programmed set of operations, such as maintenance operations.

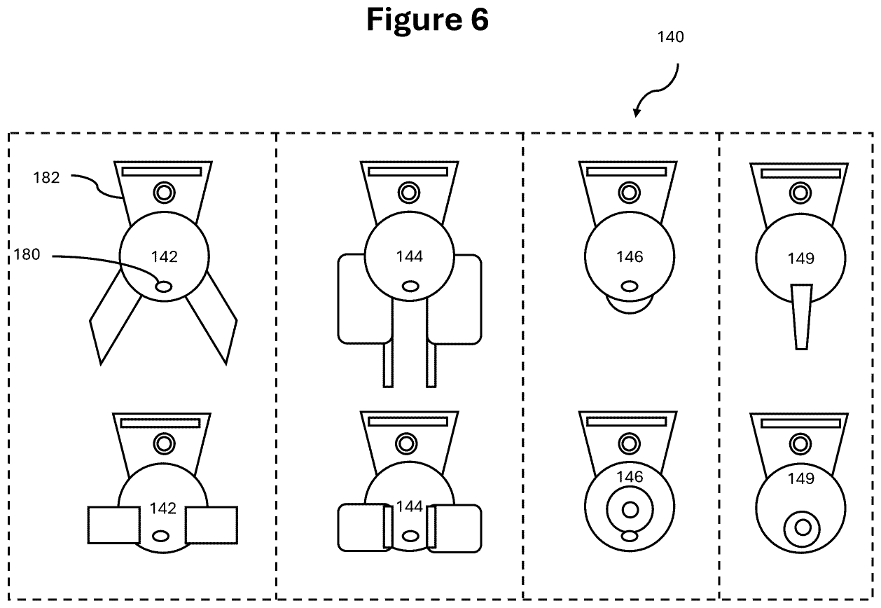

Robotic arm assembly 100 has gripper 144 designed to move cages, food, water bottles, grab and exchange cage peripherals, and perform other tasks. Optionally, robotic arm assembly 100 may, as illustrated in FIG. 6, use several tool assembly 140 types and, in these embodiments, is designed to exchange tool assemblies 140 or have tool assemblies 140 exchanged between tasks. Robotic arm assembly 100 is designed to operate safely alongside humans and thus may employ additional sensors 126, as illustrated in FIG. 2, disposed on or about robotic arm assembly 100, such as in 3D vision system 182, to permit safe collaborative work. Additionally, and also illustrated in FIG. 2, robotic arm assembly 100 is equipped with both pause switch 113A and power kill switch 113B to rapidly stop operation if so required. Sensors 126 is a general definition for any detecting device by which robotic arm assembly 100 can detect and navigate its environment and make associated decisions, and generally includes the typical domain of sensors detecting and sometimes organizing and analyzing light waves, audio waves, radiation such as heat, pressure such as weight, chemicals, attitude such as position relative to gravity, wherein the illustrated embodiment shows preferred arrangements, but which other arrangements may be deployed. Illustrated 3D vision system 182 includes several elements that will be discussed that would fall within a set, introduced in FIG. 2, called sensors 126.

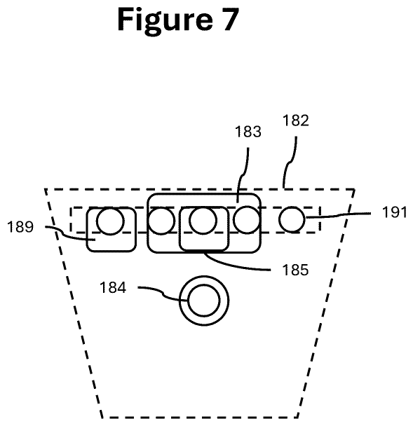

3D vision system 182 uses stereo vision, which can be enabled by, as will be illustrated in FIG. 7, stereo camera 183, which is also, therefore, a subset of sensors 26. 3D vision system 182 is designed to compute object positions, such as by the following illustration:

$$( X , Y , Z ) = ( b * f * ( u\_L - u\_R ) ) / ( d * Z ) , \\ ( b * f * ( v\_L - v\_R ) ) / ( d * Z ) , ( b * f ) / d$$

where b is baseline distance between cameras, f is focal length, (u_L, v_L) and (u_R, v_R) are pixel coordinates in left and right images, d is disparity, and Z is depth.

As further illustrated in FIG. 2, robotic arm assembly 100 includes at least one computer 110 and software program 112 configured to control robotic arm assembly 100 and which may include elements that are onboard robotic arm assembly 100, offboard robotic arm assembly 100, or both. Operating assembly 120 comprises actuators 122, controllers 124, and 3D vision system 182 for detecting object positions. Operating assembly 120 for robotic arm assembly 100 and rack assembly 155 operations includes one or more actuators 122, controllers 124, and sensors 126. Robotic arm assembly 100 includes actuators 122 responsible for converting energy into mechanical motion to move robotic arm assembly 100 and includes at least one or more of electric motors, pneumatic cylinders, or hydraulic actuators.

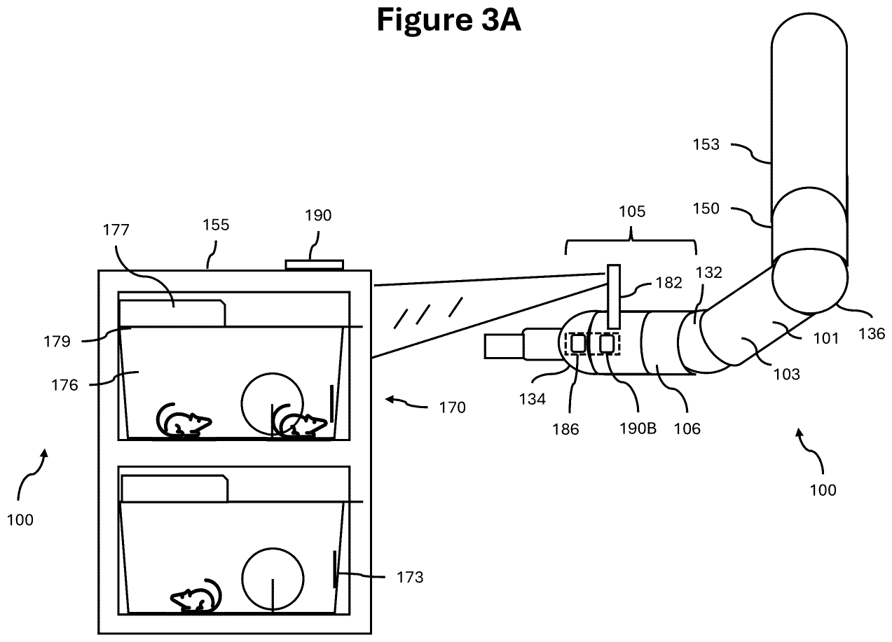

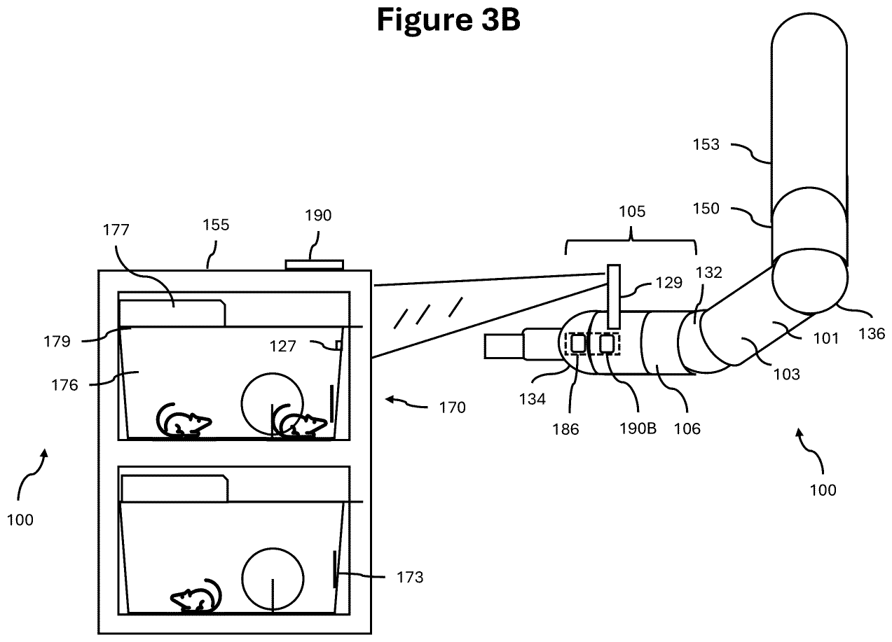

Representative actions will follow that may, for illustration, have control system 110 determine actions B based on sensor 126 observations A using Bayesian models: P(B=b|A=a)=P(A=a|B=b)*P(B=b)/P(A=a) where P(A=a|B=b) is the likelihood of observing sensor data a given action b, and P(B=b) is the prior probability of action y (e.g., cage exchange, food replenishment) where probabilities can range from 1, such as the probability that an empty food tray needs to be replenished to 0 that a full tray needs to be replenished to some probability in between such as that a mouse still for a given time t is deceased. As illustrated in FIGS. 3A-3B, smart cage sensor array 177 also provides information that would become an observation Aᵢ from many possible observations A₁, . . . , Aₙ. Other sensors may be used if designed to communicate with computer system 110.

Robotic arm assembly 100 includes controllers 124 designed to manage operation of actuators 122, receiving input signals from at least one computer system 110 and translating signals into appropriate commands for precise movement control.

Robotic arm assembly 100 includes sensors 126 designed to provide feedback to controller 124, enabling robotic arm assembly 100 to perceive its environment and adjust its movements accordingly. Examples include position sensors 187, force/torque sensors 186, and proximity sensors 188.

Robotic arm assembly 100 includes a power source, such as batteries or a power grid connection, to supply energy to actuators 122 and other electronic components of robotic arm assembly 100.

Robotic arm assembly 100 includes software program 112 that controls operations of robotic arm assembly 100, specifying tasks, movement trajectories, and interaction with the environment. This may involve programming languages, algorithms, and user interfaces 111 for human interaction and control.

FIGS. 3A, 3B, and 4A-4C further illustrate that robotic arm assembly 100 is designed to work with smart cage assemblies 170 and monitoring cages 172 that are designed to be compatible with automated cage changes. Each smart cage assembly 170, including external sensor array 177, is designed for monitoring animal health. External sensor array 177 (which is not changed and does not come into contact with animals), and internal cage tops 179 and cage bottoms 176 (which are changed or cleaned). Internal cage top 179 and bottom 176, in some embodiments, can be made of single-use vacuum-formed plastic to remove costs and logistical difficulty of cage washing. Of note, sensor array 177 will have sensors for measuring the condition of smart cage assembly 100 environments and animals within, which may communicate with systems associated with robotic sensors 26 but are not within sensor 26 sets.

FIG. 3B illustrates that some embodiments of robotic arm and rack assembly 10 may use an RFID-based localization system to guide robotic arm assembly 100 in engaging smart cage assemblies 170 on rack assembly 155, replacing or supplementing 3D vision system 182 with RFID sensors 127 embedded on each smart cage 170, food container, water bottle, and other objects, and an RFID reader 129 such as may be integrated into tool assembly 140 or port assembly 153. Each RFID sensor 127 encodes a unique identifier and positional data, enabling RFID reader 129 to detect the presence, identity, and approximate location of a target object within a detection range (e.g., 0.5-1 meter), with software program 112 mapping these signals to precise coordinates relative to port assembly 153 position on rail assembly 160. Robotic arm assembly 100, controlled by joint angles (shoulder 136, elbow 132, wrist 134) via an inverse kinematics solver or spherical coordinates (ρ, θ, φ), navigates to the detected object, refining its position using signal strength and triangulation from multiple RFID readings, and executes tasks such as cage exchanges, food replenishment, or connecting cages via inlet port 173. Real-time feedback from RFID reader 129, combined with force/torque sensors 186, ensures accurate engagement without direct contact, while software 112 adapts RFID data to adjust for cage shifts or misalignments. RFID sensors 127 may further be included on animals such as might be used to determine that animals have passed through tunnel 175 before disengagement of cage 170, 171, 172.

FIG. 4A illustrates smart cage assemblies 170, as is also the case for monitoring cages 171 and port cage 172, are designed to be compatible with automated cage changes wherein it should be understood that actions and element described for smart cage assembly 170 may also apply to monitoring cages 171 and port cages 172, which all may further have identical or similar cage tops 179 and cage bottoms 176 and may further be interchangeable. Robotic arm assembly 100 and rack assembly 155 are designed to automate smart cage assembly 170 change process. Internal cage top 179 and internal cage bottom 176 are typically made of single-use vacuum-formed plastic to remove cost and logistical difficulty of cage washing, but washable cage tops 179 and cage bottoms 176 may be used. As illustrated in FIG. 1, smart cage assemblies 170 are housed in a rack assembly equipped with a 6-degrees-of-freedom robotic arm assembly 100 that can move via gantry robot 116 along Y, Z rails 160 outfitted on about rack assembly 155, as well as complete full X, Y, Z ranges of motion via robotic arm assembly 100. This positioning technology is used in industrial-scale 3D printers. Robotic arm assembly 100 has tool assembly 140 to be able to move cages 170, food, water bottles, grab and exchange cage peripherals, and perform other tasks. As illustrated with examples in FIG. 6, several tool assemblies 140 may be exchanged between tasks. Robotic arm assembly 100 is designed to operate safely alongside humans (although not necessarily in the immediate vicinity) and thus may employ additional sensors 126 on other structures and/or attached to robotic arm assembly 100, to permit safe collaborative work. Additionally, as noted for FIG. 2, the invention is equipped with both pause switch 113A and power kill switch 113B to immediately stop operation if so required.

As further illustrated in FIG. 4A, in some embodiments of smart cage assembly 170 for housing and assaying multiple vertebrate animals, robotic arm assembly 100 is operationally coupled to move horizontally and vertically substantially along the entirety of the height and width of rack assembly 155 and is further designed to remove housing assemblies at least partly from rack assembly 155. Rail system 160 and articulation joints 132, 134, 136 of robot arm assembly 100 allow tool assemblies 140 such as grippers 144 to be positioned as required and moved along vectors of a three-dimensional space x, y, z, at given times tₙ, that permits at least partial removal of smart cage assembly 170, monitoring cage 171, port cage 172 from associated rack assembly 155. Robotic arm assembly 100 may be apart from rack assembly 155, such as robotic arm assemblies 100 disposed on, as illustrated in FIGS. 4B-4C, an autonomous ground vehicle 165 or on an independent rail system 166 such as magnetic floor pathways 166M and, therefore, lacking gantry robot 116, which role is replaced by said autonomous ground vehicle 165. Autonomous ground vehicle 165 would include (a) a navigation module configured for simultaneous localization and mapping (SLAM) or comparable spatial awareness; and (b) an onboard power supply and communication link with required sensors 126 and sensor array 177. In principle, particularly where independent rail system 166 is used, this embodiment is simply an inversion of engineering principles described so far wherein independent rail system 166 is ground-based instead of ceiling-based rail 160 and autonomous ground vehicle 165 has the same role as gantry robot 116. In some embodiments, rail 160 itself and gantry 116 itself could, effectively, be installed from the ground up.

FIGS. 4A-4B further illustrate that to provide biocontainment, robotic arm assembly 100 and rack assembly 155 may be housed in a modular room, a representative example illustrated composed of the holding room (with robotic arm assembly 100) and an adjacent procedure room. Vertebrate animals and day-to-day care are designed to happen in the holding room, whereas any manual measurements or manipulations are carried out in the procedure room. Based on one representative calculation, at roughly 70% robot uptime, one room can house approximately 2000 mice. To provide overhead space for robotic arm assembly 100, movement, air, water, and power lines are typically connected to rack assemblies 155 through floors. For this reason, the entire module, in this representative embodiment, is lifted above floor level and held on a platform. The room is also designed in a way that robotic arm assembly 100 can access food, bedding, water, and drug storage areas, and can place used cages 170, 171, 172 in cage waste removal regions. Each module also contains its own air and water filtration systems and source, whereby both incoming and outgoing air is HEPA filtered, and outgoing air is further sampled for growth of mouse pathogens.

In some embodiments, robotic arm assembly 100 provides an added benefit of creating a sterile environment wherein human entry into given rooms can be limited or eliminated. Entering a module, in this embodiment, requires donning of gowning that fully covers the body, and the module is kept at slightly increased internal air pressure to reduce entry of unclean air. The module embodiment is designed to be constructed rapidly out of components that are not subject to supply chain risk, to be minimally expensive, and to have backup systems for critical life support. Therefore, another object of the invention is to design a system that can be inexpensively and quickly deployed as scaling needs dictate, while being sufficiently robust to buffer against various forms of service interruption, and these expenses may be relative to a comparable system.

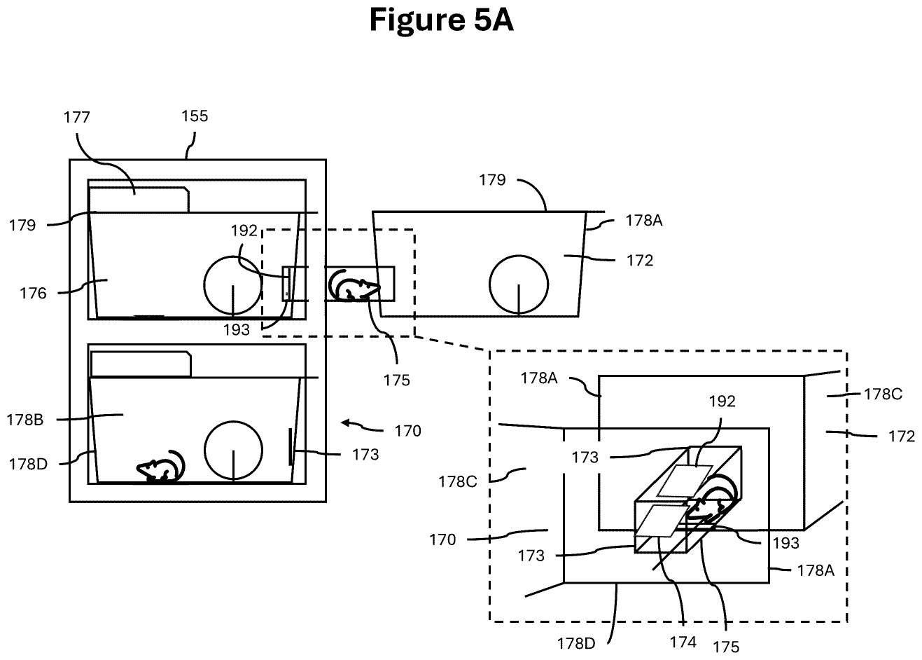

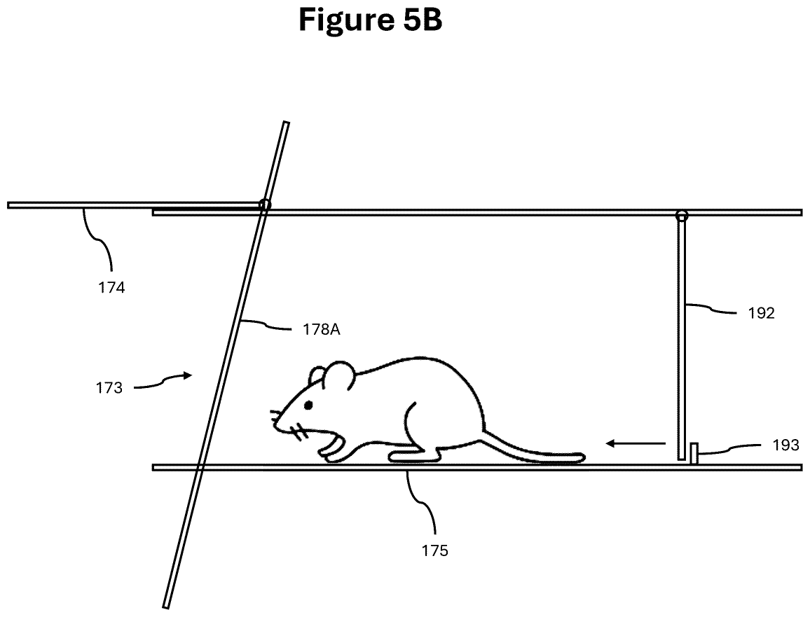

FIGS. 5A-5B illustrate elements required for smart cage assembly 100 changes, including port cage 172 for moving or temporarily holding rodents, inlet port 173, tunnel 175 by which rodents can travel between smart cages 170, 171, 172, and door 174, elements that can be a part of any front cage wall 178A, first side cage wall 178B, second side cage wall 178C, or back cage wall 178D. Further illustrated are cage bottom 176 and cage top 179, cage top 179, which may be hinged or sectional so that the entire cage top 179 need not be removed to fully access cage bottom 176. Tunnel 175 may include one-way valve 192 that allows animals to move one way through tunnel 175 but prevents back movement such as by having stop 193 included. Insertion of tunnel 175 may cause door 174 to open which may otherwise be closed by spring action or gravity.

FIG. 6 illustrates tool assembly 140, which is interchangeably equipped with at least one of claw tool assembly 142, gripper tool assembly 144, rotational tool assembly 146, or dispenser tool assembly 149. Tool assembly 140 is configured to engage smart cage assemblies 170 for automated maintenance tasks.

FIG. 6 illustrates that robotic arm assembly 100 engagement with smart cage assemblies 170 may be conditional upon receiving sensor 126 or sensor array 177 data that robotic arm assembly 100 is designed to address. Robotic arm assembly 100 engagement with smart cage assemblies 170 may be based on a schedule. Robotic arm assembly 100 tool assembly 140 may be a gripper tool assembly 144. Robotic arm assembly 100 tool assembly 140 may be interchangeable from a group including at least: claw tool assembly 142, gripper 144, rotational tool assembly 146, and dispenser tool assembly 149. Other tool assemblies 140 may be used. Robotic arm assembly 100 may include at least one optical sensor 180 disposed on robotic arm assembly 100.

FIG. 7 illustrates representative 3D vision system 182 having stereo camera system 183, structured light sensor 184, and time-of-flight camera 185, configured to detect sizes, shapes, and 3D distances of objects within or about rack assembly 155 for precise engagement by tool assembly 140. Further, IR sensor 191 may be included as may be used to detect IR signatures of rodents.

Representative robot 100, 116 tasks include, but are not limited to:

Exchange of in-cage peripherals (2) - Food
and water bottle (Once every 2 weeks)

| Operation | Automated Task |
|---|---|
| Pick up food from a (possibly | Vision + Pick |
| refrigerated) container at the side of | |
| the room | |
| Weigh amount of food picked up, | Pick + Place |
| store data in an internal log | |
| Move food close to cage 170, 171, | Motion Planning: robot arm 100 |
| 172 | stowed; gantry robot 116 moves to |
| | target smart cage 170, monitoring |
| | cage 171, or port cage 172 |
| Open cage door 174, pull out cage | Vision + Grasp + Motion |
| 170, 171, 172, and remove cage top | Planning |
| 179 | |
| Add food into cage 170, 171, 172 | Vision + Place |
| Replace cage top 179, close cage | Vision + Pick + Place |
| door 174 | |
| Place food container back onto a | Vision + Place |
| storage area | |

Exchange in-cage peripherals (Once every study cycle: 1
week-3 years. On average couple of months or 6 months)

| Operation | Automated Task |
|---|---|
| Remove cage 170, 171, 172 from rack assembly 155 | Vision + Pick |
| Either screw off or pop open peripherals of cage | Vision + Pick |
| 170, 171, 172 | (Screw) |
| Discard the peripherals | Place |
| Pick up new peripherals from a storage area | Vision + Pick |
| Screw on or pop on new peripherals | Vision + Place |
| | (Screw) |
| Replace cage 170, 171, 172 | Vision + Place |

Wipe cage 170, 171, 172 enclosure (once a month)

| Operation | Automated Task |
|---|---|
| Pick up an ethanol-soaked cloth | Vision + Pick |
| Wipe the inside of internal cage bottom 176 | Vision + Motion |
| | Planning |
| Discard cloth | Vision + Place |

Weigh food prior to addition (once every 2 weeks)

| | Automated |
|---|---|
| Operation | Task |
| Pick up food with food container | Vision + |
| | Pick |
| Place on scale (either electrically connected or | Vision + |
| record via on-board camera 189), record value | Place |

Placement of objects inside cage 170 (once every 2 months)

| Operation | Automated Task |
|---|---|
| Pick objects such as run wheels, climb poles, etc., | Vision + Pick |
| As a modification of cage 170, 171, 172 exchange | Vision + Place |
| process, place objects (run wheels, climb poles, or | |
| others into cage 170, 171, 172) | |
| The above stored either at a side of the room or on | Vision + Place |
| one of rack assembly 155 | |

Weigh water bottle prior to addition

| Operation | Automated Task |
|---|---|
| Pick up pre-made water bottles from refrigerator | Vision + Pick |
| Place on scale (either electrically connected or record | Vision + Place |
| via on-board camera 189), record value | |

Move cages 170, 171, 172 between stations (once a day
max to never, study depending. Once a month average)

| Operation | Automated Task |
|---|---|
| Move cage 170, 171, 172 containing mice from rack | Vision + Pick + |
| assembly 155 to a pass-through window or a | Motion Planning + |
| different rack assembly 155 | Place |

Placement of new cages 170, 171, 172 onto rack assembly 155

| Operation | Automated Task |
|---|---|
| Move near storage unit | Motion Planning |
| Pick up new rack assemblies 155 from storage unit or | Vision + Pick |
| placement within reach of robot arm assembly 100 | |

Placement of spent cages 170, 171, 172 onto
collection bins (Once every two weeks)

| Operation | Automated Task |
|---|---|
| Pick up spent cage 170, 171, 172 | Vision + Pick |
| Move spent cage 170, 171, 172 near collection bin | Motion Planning |
| Place cage 170, 171, 172 in collection bin | Vision + Place |

System features in representative embodiments include, but are not limited to:
Rack assemblies 155
Feed storage
Water bottle/Food trays
Cage peripherals
Cage cleaning/disinfection
Floor cleaning
Payload: 4 kg
Robotic arm assembly 100
Robotic gantry 116 and inlet port 173
Ability to perform cage 170, 171, 172 exchange process
Ability to interact with objects of various shapes
Ability to retrieve dead rodents from cages 170, 171, 172
Ability to operate with objects in flexible locations: i.e. adaptability to slight movement/location
changes of cages 170, 171, 172 and other objects
Ability to move in 3D space
Ability to exchange individual cage components (such as water or air inlet valve, pull bar)
Speed: ability to complete steps for one cage 170 exchange within 5 minutes
Speed: ability to complete steps for adding food to a single cage 170 in 3 minutes
Speed: ability to complete steps for replacement of a water bottle to one cage 170 within 3 minutes
Modularity and interoperability: must be modularly replaceable, with readily available alternative robot tool assemblies 140, which themselves may be robotic
Collaborative: safe operation alongside human operators
Safety: kill switch 113B
Safety: pause switch 113A
Adaptability: user-controlled pause or skip of current operation

Hardware features in representative embodiments include, but are not limited to:
1. Linear Robotic System: A representative embodiment includes workspace 9 L×7.2 D×4 H meter with payload up to (manipulator, 3D vision system 182, gripper 144, adapters, max payload) kg.
2. Manipulator: A representative embodiment includes 6 DOF serial robot with workspace to cover minimum 0.5 m and weight up to 12 kg. The manipulator should be able to carry 3D vision system 182 and at least one tool assembly 140, such as gripper 144.
3. 3D Vision system 182: As illustrated in FIG. 7, a representative embodiment includes (Stereo camera system 183, Structured Light Sensor 184, Time of Flight (TOF) Camera 185, Monocamera+markers), and standard camera 189. 3D vision system 182, which has high enough resolution for its tasks, a large workspace, and is capable of detecting size, shape, and 3D distance of features.
4. Grippers (magnetic, vacuum, parallel): A representative embodiment includes robotic arm assembly 100 equipped with tool assembly 140, such as gripper 144 or other elements of tool assemblies 140, such as claw 142 that can pick objects of various sizes. The selection of tool assembly 140, such as gripper 144, is determined by the objects present in rack assembly 155, which may be termed, in embodiments, a Roborack assembly system. It is feasible to employ multiple tool assemblies 140 on robotic arm assembly 100 to pick up or place objects of different types.
5. Calibration target: A representative embodiment includes: to execute hand-eye calibration, a calibration target is utilized, and its dimensions and shape are dependent on the 3D vision system 182 type and machine vision capabilities of the system. Usually, the calibration target contains a characteristic feature, such as a circular hole with a sharp edge, which 3D vision system 182 can detect and measure the center in its coordinate frame. Other alternatives include the spherical target and irregular tetrahedron targets.
6. Adapter: A representative embodiment includes adapters used to connect 3D vision system 182 and grippers 144 to a robot flange.
7. Torque/force sensor 186: A representative embodiment, as illustrated in FIGS. 3A-3B, include force/torque sensor 186 designed to detect the level of force exerted on objects while picking, placing, and wiping, thereby preventing damage to both the objects and smart cage assemblies 170, 171, 172.
8. Service Table: Representative embodiments include, but are not limited to, hardware options: Arm:

| | | | | | | | | | Pose |
|---|---|---|---|---|---|---|---|---|---|
| | | | | Cost | Payload | Reach | | Mass | Repeatability |
| Brand | Model | Country | Cobot | (USD) | (kg) | (mm) | DoF | (kg) | (mm) |
| ABB CRB | GoFa 15000 | Switzerland | Yes | 42,500 | 5 | 950 | 6 | 27 | 0.006 |
| AUBO | i5 | China | Yes | 21,500 | 5 | 886.5 | 6 | 24 | 0.05 |
| Dobot | CR5 | China | Yes | 21,700 | 5 | 900 | 6 | 25 | 0.02 |
| Doosan | A0509 | Korea | Yes | 28,000 | 5 | 900 | 6 | 21 | 0.03 |
| Fanuc | CRX-5iA | Japan | Yes | Not Available | 5 | 994 | 6 | 25 | 0.03 |
| Hanwha | HCR-5 | Korea | Yes | 25,900 | 5 | 915 | 6 | 21 | 0.05 |
| Kassow | KR1205 | Denmark | Yes | 34,000 | 5 | 1200 | 7 | 25 | 0.1 |
| KUKA | LBR iiwa 7 | Germany | Yes | Not Available | 7 | 800 | 7 | 23.9 | 0.1 |
| | R800 | | | | | | | | |
| Universal | UR5e | Denmark | Yes | 36,000 | 5 | 850 | 6 | 18 | 0.03 |
| Robots | | | | | | | | | |
| UFactory | xArm 6 | China | Yes | 10,000 | 5 | 700 | 6 | 12.2 | 0.1 |
| Siasun | GCR7-910 | China | Yes | Not Available | 7 | 917 | 6 | 21 | 0.03 |
| Rokae | CR7 | China | Yes | 13000 | 7 | 850 | 6 | 27 | 0.03 |

### a) Gantry 116:

| | | | Cost | Payload | Reach X | Reach Y | Reach Z | Repeatability |
|---|---|---|---|---|---|---|---|---|
| Brand | Model | Country | (USD) | (kg) | (mm) | (mm) | (mm) | (mm) |
| Gudel | FP-3 | Germany | 150,000 | 50 | 7500 | 4272 | 1000 | |
| Kuka | KR80L | Germany | | 80 | Up to | 2000 | 2500 | 0.1 |
| | | | | | 45000 | | | |
| Vention | Custom | USA | 70,000 | | 4112 | 3642 | 2334 | |

### b) Software Requirements

1. Automation Engine and Communication Software

A representative embodiment includes software 112 application links for various industrial devices, including robot controllers 124, 3D vision systems 182, programmable logic controllers 124 (PLCs), and third-party software 112 packages. This application includes tool assemblies to automatically trigger measurements, process measurement results, export data, and communicate the results to gantry robot 116 and robotic arm assembly 100.
2. 3D Image/Point Cloud Processing Software

A representative embodiment includes, as a part of software 112, basic extraction tool assemblies for geometries such as Hole, Plane, Point, 3D Distance Calculation, and 3D Template Matching.
3. Graphic User Interface 111

A representative embodiment includes that the user can use GUI (a version of interface 111) to get access to a Roborack assembly system log, plan automated tasks, add new robotic tasks, remove the existing automated tasks, check robot and sensor connectivity, etc.

### c) Software Solutions

1. Robotic Hand-eye Calibration:
2. A representative embodiment includes a process of determining transformations between coordinate systems of, for example, stereo camera system 183 (eye) and its end-effector, such as gripper 144 (hand). Calibration involves computing a relative pose of camera 183 with respect to end-effectors such as tool assembly 140, which is important for accurately controlling movement of robots 100, 116.
3. TCP Calibration:

A representative embodiment includes a process of determining the position of the physical or virtual gripper 144 relative to robots 100, 116.
4. Robot Arm Joint 132, 134, 136 Offset Calibration:

A representative embodiment includes joint encoders of robotic arm assembly 100 that can address reduced accuracy over time and compensate for joint 132, 134, 136 offset to improve robotic arm assembly 100 accuracy.
5. Robotic Arm Assembly 100 Calibration:

A representative embodiment includes that robotic arm assembly 100 is moved to target poses with error, and there may be a need to calibrate kinematic parameters of robotic arm assembly 100. This process improves accuracy of robotic arm assembly 100. Robotic arm assembly 100 typically achieves precise positioning within rack assembly 155 using a 6-degrees-of-freedom (6-DOF) kinematic model. The position of the tool assembly 140 in Cartesian coordinates (x, y, z) can be computed via forward kinematics:

$$x = f ( {θ}_{1} , {θ}_{2} , … , {θ}_{6} , {l}_{1} , {l}_{2} , … , {l}_{5} )$$

$$y = g ( {θ}_{1} , {θ}_{2} , … , {θ}_{6} , {l}_{1} , {l}_{2} , … , {l}_{5} )$$

$$z = h ( {θ}_{1} , {θ}_{2} , … , {θ}_{6} , {l}_{1} , {l}_{2} , … , {l}_{5} )$$

where θ₁, to θ₆ are joint angles at joints (132, 134, 136), and l₁ to l₅ are link lengths. Inverse kinematics solve for θ₁, to θ₆ given a target position (x, y, z) and orientation, using numerical methods to handle the 6-DOF complexity. For tool assembly 140 vectoring, tool assembly 140 may operate in polar coordinates (r, θ, z) relative to port assembly 153:

$$r = √ ( {x}^{2} + {y}^{2} )$$

$$θ = a tan 2 ( y , x )$$

$$z = z$$

This dual-coordinate approach enables precise engagement with smart cage assemblies 170, 171, 172.
6. Gantry Robot 116 Calibration:

A representative embodiment includes encoders in gantry robot 116, which may need calibration to avoid error when moving robotic arm assembly 100 to target positions.
7. Motion Planning:

A representative embodiment includes complex tasks of pick and place applications that require careful motion planning to avoid arm singularity, arm joint 132, 134, 136 limits, and arm collision with objects and itself. This step requires a trajectory prediction before robot 100, 116 is sent to target locations. Motion planning can be performed in joint space or task space.
8. Cage 170, 171, 172 Shift Detection and Robot 100, 116 Motion Adjustment:

A representative embodiment includes that robotic arm assembly 100 is trained for each automated task. Trained robot 100, 116 motion along with 3D image/point clouds of smart cage assemblies 170, food/water container. etc., are considered as the reference. For a given 3D image of the smart cage assembly 170, food/water container, software 112 compares two images/point clouds and calculates differential transformations that will be applied to reference robot 100, 116 motion, and robot 100, 116 will reach target pose accurately.

Software 112 in representative embodiments include, but are not limited to:
1. Mech Design software: SolidWorks
2. Simulation software: RoboDK,
3. Middleware: ROS, ROS2
4. OS: PLC vs Ubuntu
5. Cloud Storage Service: Google Drive
6. Requirement Management Tool assembly: Jama

Robot 100, 116 time and serviceable unit number representative estimations:

| | | Time | |
|---|---|---|---|
| | | estimate | |
| Task | Frequency | (worst case) | |
| Cage 170 exchange | Once every two weeks | 10 | min |
| Placement of spent cages | Once every two weeks | 1 | min |
| 170 onto a collection bin | | | |
| Moving cages 170 between | Once a day max to never. | 2 | min |
| stations | Once a month average | | |
| Weighing water bottle prior | Once every 2 weeks | 1 | min |
| to addition | | | |
| Placement of new cages | Once every 2 weeks | 2 | min |
| 170 onto selected rack | | | |
| assembly 155 | | | |
| Placement of objects inside | Once every 2 months | 5 | min |
| cage 170 | | | |
| Exchange of in-cage | Once every study cycle: 1 | 10 | min |
| peripherals | week-3 years. On average | | |
| | couple of months or 6 months | | |
| Wipe cage 170 enclosure | Once a month | 5 | min |
| Total | Worst average: once per 2 | ~30 | min |
| | weeks | | |
| Total number serviceable | | 537 | cages |
| cages 170, 171, 172 at 80% | | | |
| uptime: | | | |

A representative embodiment for automated mouse rearing includes rack assembly 155 that houses an 11×7 grid of smart cage assemblies 170, which are individually supplied with filtered air, purified water, and power. Rack assembly 155 is maintained by robotic arm assembly 100 mounted on movable YZ rails 160 and equipped with gripper 144 and camera 189. Robotic arm assembly 100 performs cage 170, 171, 172 changes, feed addition, and other daily tasks. Data feed from each individual smart cage assembly 170 is input to robot arm 100 control to control which smart cages 170, monitoring cages 171, or port cages 172 need maintenance and when.

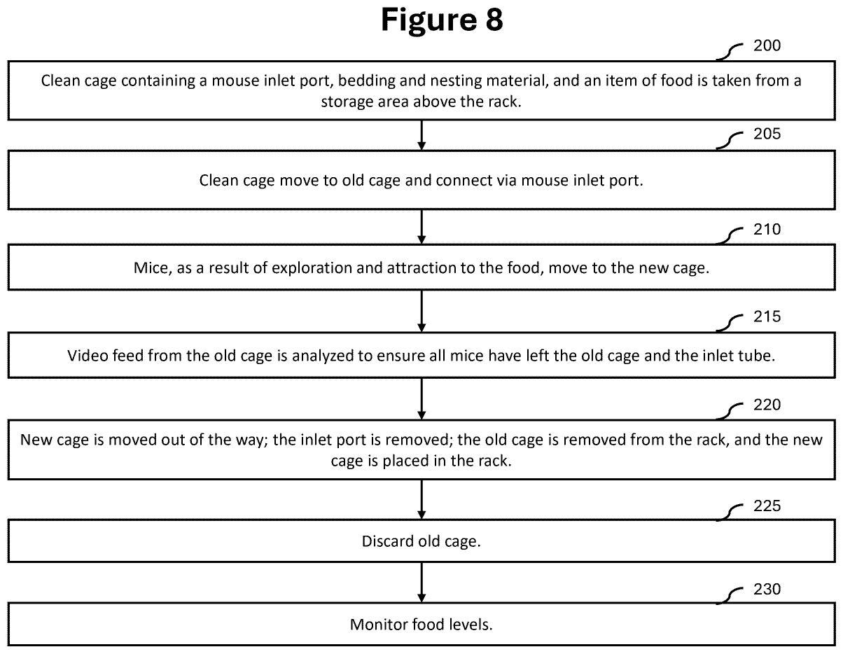

FIG. 8 illustrates elements of a representative robotic arm assembly and rack assembly 10 process, as follows:
1. Step 200, a clean cage 170 containing mouse inlet port 173, bedding and nesting material, and an item of food is taken from storage area above rack assembly 155.
2. Step 205, clean cage 170 is moved to old cage 170 and connected via mouse inlet port 173. Mouse inlet port 173 leads to tunnel 175 with unidirectional valves to new cage 170.
3. Step 210, mice, as a result of exploration and attraction to food, move to new cage 170.
4. Step 215, video feed from old cage 170 is analyzed to ensure all mice have left old cage 170 and inlet port 173.
5. Step 220, new cage 170 is moved out of the way; inlet port 173 is removed; old cage 170 is removed from rack assembly 155, and new cage 170 is placed in rack assembly 155.
6. Step 225, old cage 170 is discarded.
7. Step 230, food levels are monitored from video data in each rack assembly 155.

Food is added to cage 170, 171, 172 when necessary, using same robotic arm assembly 100 by food containers placed at the top of rack assembly 155. This ensures the necessary flexibility, since usually food needs to be replaced at different rates for different cages 170 and this method allows the food source to be uniquely specified for each cage 170, 171, 172 (thus supporting custom diets).

Robotic arm assembly 100 may be at least partially operated manually by way of a user interface 111 operationally coupled to computer system 110. Robotic arm assembly 100 may be designed to halt operations before robotic arm assembly 100 contacts a person.

Software program 112 of robotic arm assembly 100 may be designed to learn patterns and make predictions autonomously. Robotic arm assembly 100 software program 112 may use data from which patterns are derived, wherein the data includes data generated by sensors within smart cage assemblies 170. Software programs 112 may be machine learning programs and may include supervised learning, unsupervised learning, and reinforcement learning. Conditional operations of robotic arm assembly 100 may be based upon machine learning algorithms, such as determining when robotic arm assembly 100 should intervene to handle a problem detected in smart cage assemblies 170, 171, 172.

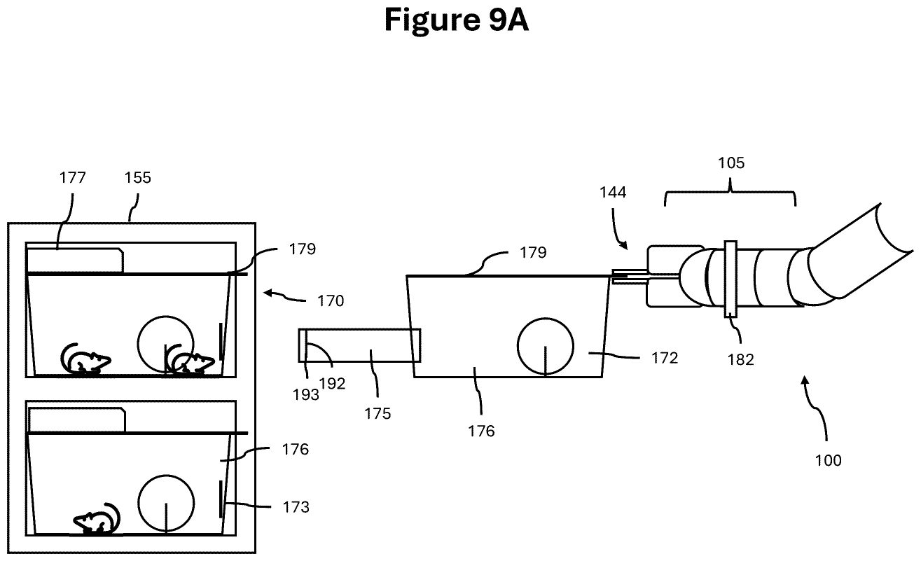

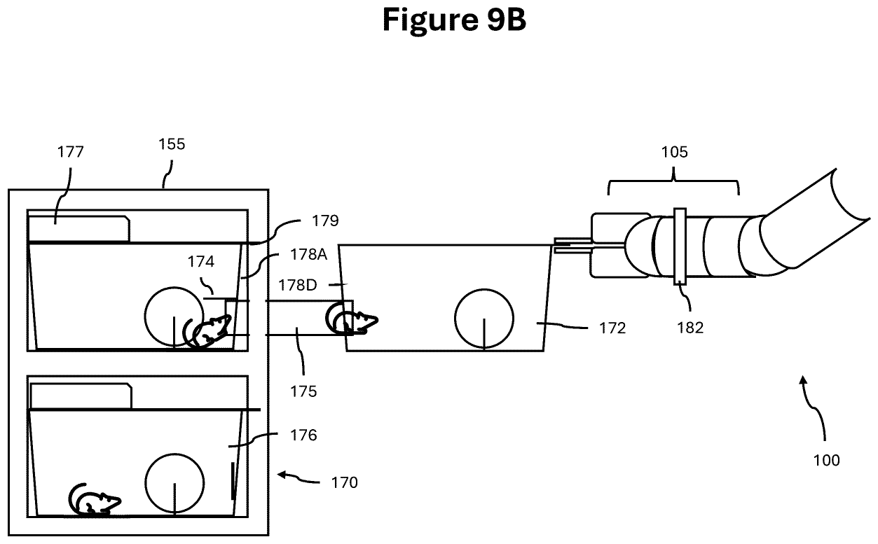

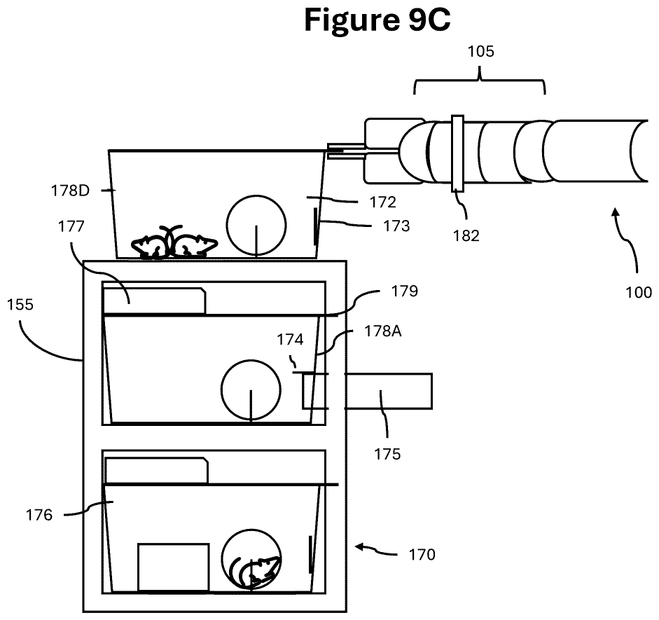

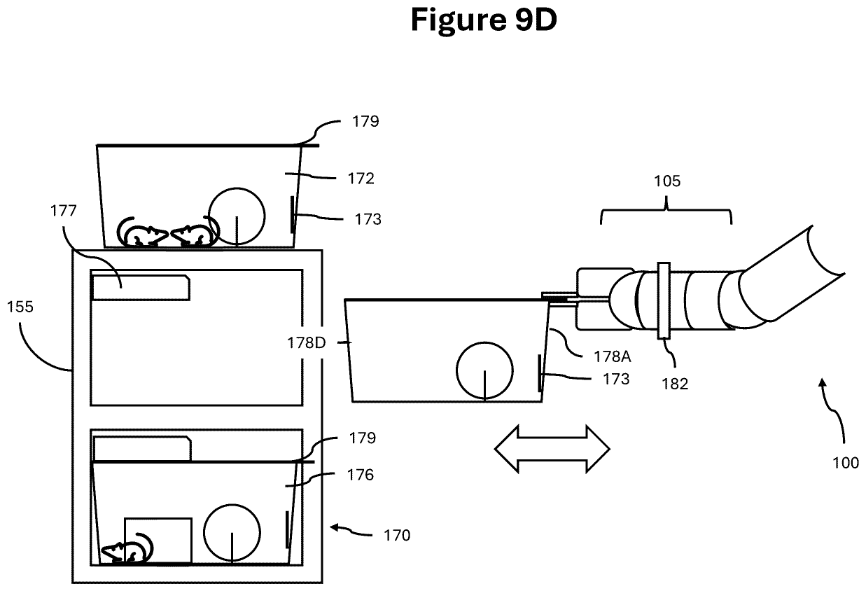

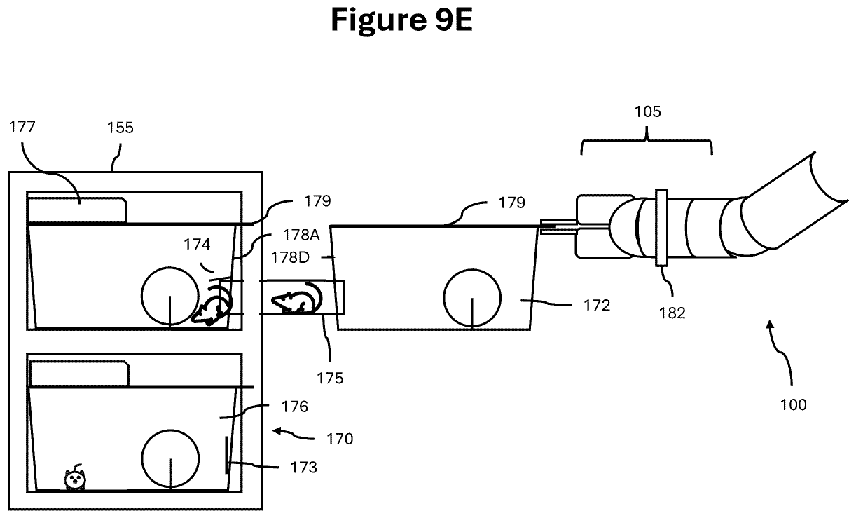

FIGS. 9A-9E further illustrate port cage 172 for automated animal cage exchange. An embodiment of port cage 172 comprises cage bottom 176, a hole in one or more of cage walls 178A, 178B, 178C, 178D (inlet port 173), door 174 enclosing inlet port 173, and a mechanism such as a spring or spring-back substance to seal door 174 when smart cage 170, monitoring cage 171, port cage 172 exchange is not in process. Such a mechanism may be cage top 179, which by its weight seals door 174 when cage exchange for given cages 170, 171, 172 are not in process. Additional mechanisms may include spring-loading, clip, rubber friction, magnetic friction, and other methods of generating friction or closing forces. Further, the wall 178A, 178B, 178C, 178D to which inlet port 173 is connected may be slanted forward to increase stability of cage 170, 171, 172 closure when using weight-based closure. Processes of connecting cages: a robot arm assembly 100 or human operator connects tunnel 175 to smart cage 170, monitoring cage 171, and/or port cage 172, by applying force to cage door 174 with tunnel 175. This force overcomes force of linking door 174 to inlet port 173 opening. Tunnel 175 may further be one-way to encourage one-way movement of animals. The procedure is then repeated with a second cage 170, operatively connecting two cages 170, 171, 172 together. Finally, various forms of positive or negative incentives can be used to encourage movement of animals from one cage 170, 171, 172 to another cage 170, 171, 172, such as placing food and water compartments into new cage 170, or applying light, sound, vibration, or other undesirable stimuli to old cage 170.

In some embodiments, robotic arm assembly 100 is designed by way of tool assembly 140, to connect two or more smart cage assemblies 170, monitoring cage 171, port cage 172 with tunnel 175. In some embodiments, robotic arm assembly 100 is designed to produce incentives to encourage mouse movement, wherein incentives include but are not limited to placing food and water compartments into cages 170, 171, 172, or applying light, sound, vibration, or other undesirable stimuli.

Smart cage assembly 170 and robotic arm assembly 100 system may further contain automated restraining, anesthetizing, injection, and blood collection systems to perform injections and blood draws on vertebrate animals within smart cage assembly 170.

FIGS. 9A-9E further illustrates that robotic arm assembly 100 is configured to perform automated maintenance tasks, including cage 170, 171, 172 exchanges, food and water replenishment, and cage 170, 171, 172 enclosure cleaning, based on sensor data from smart cage assembly 170 sensor array 177 or a predefined schedule, and to connect smart cage assembly 170, 171, 172 assemblies via inlet port 173 to transfer animals without direct contact by robotic arm assembly 100 or a person. In some embodiments, automated smart cage assembly 170, 171, 172 exchanges include that robotic arm assembly 100 is configured to remove a used smart cage assemblies 170, 171, 172 from rack assembly 155, connect a clean smart cage assembly 170 to used smart cage assembly 170 via inlet port 173, and use incentives to encourage animal movement to clean smart cage assembly 170. Incentives may include at least one of placing food or water in the clean smart cage assembly 170 or applying light, sound, or vibration to given used smart cage assembly 170. Robotic arm assembly and rack assembly 10, in this representative embodiment, includes 3D vision system 182 having at least one of stereo camera system 183, structured light sensor 184, and time-of-flight camera 185, configured to detect sizes, shapes, and 3D distance of objects within rack assembly 155 for precise engagement by tool assembly 140.

Robotic arm assembly 100 may include force/torque sensor 186 operably coupled with tool assembly 140, force/torque sensor 186 configured to detect the level of force exerted during automated maintenance tasks, especially to prevent damage to smart cage assemblies 170, 171, 172 or objects. Robotic arm assembly 100 may be configured to weigh food or water prior to replenishment by placing a food container or water bottle on a scale 190 and recording the weight using an onboard camera 189 or an electrical connection to scale 190. Some embodiments may include robotic arm scale 190B as a weighing device. Robotic arm assembly 100 may further include machine learning modules of software 112 configured to learn patterns from sensor array 177 data generated by smart cage assemblies 170 and predict maintenance needs autonomously. Robotic arm assembly 100 may be configured to move smart cage assemblies 170, 171, 172 between rack assembly 155 and a pass-through window or a holding rack assembly for experimental or maintenance purposes, the movement being guided by 3D vision system 182.

It should be noted that adaptive info is not required to do cage 170 exchanges, e.g. a fixed frequency could be used (e.g., number of days) Other heuristics, such as ambient ammonia levels, could be used instead of pattern recognition to determine cage 170 maintenance.

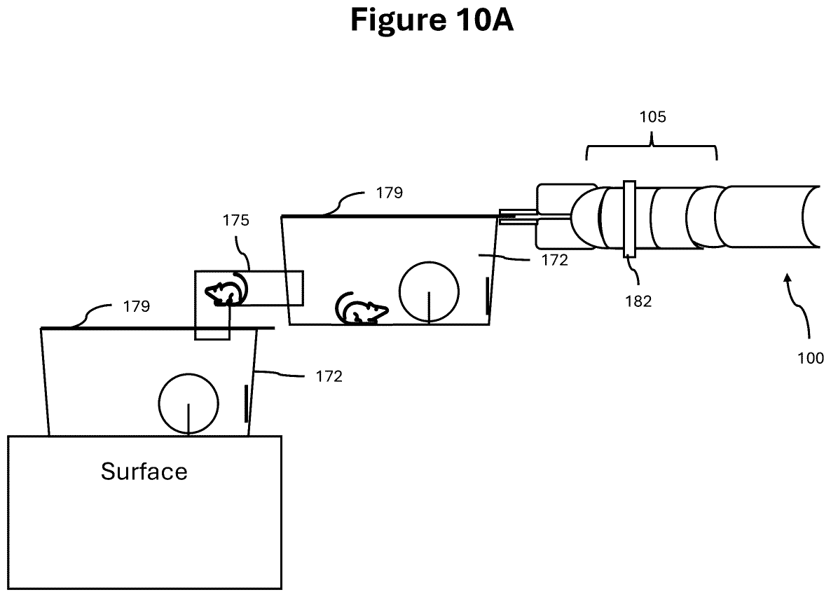

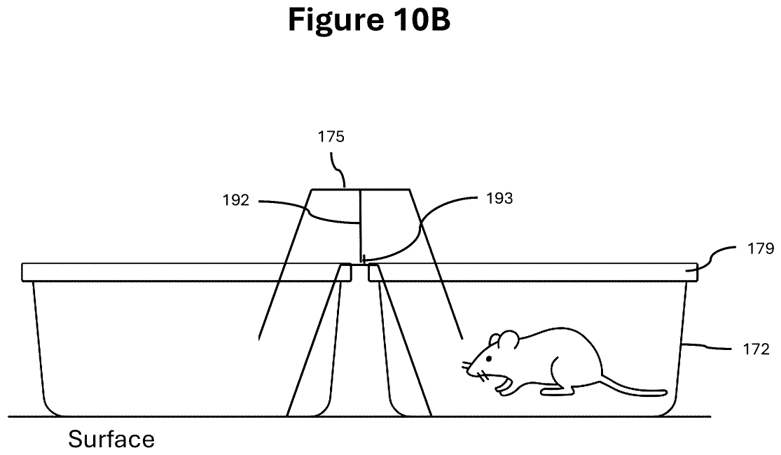

FIGS. 10A-10B illustrate that inlet port 173 may be connected by tunnel 175 by way of at least one internal cage top 179 when given cage 170, 171, 172 is on an open surface or partly extracted from rack assembly 155. Tunnel 175 can be configured so rodents can climb into or out of tunnel 175. Such an arrangement can also be designed to be naturally one-way for travel once rodents drop down from tunnel 175 and into connected cage 170, 171, 172 through give internal cage top 179 if rodents cannot climb back up into tunnel 175.

Various related embodiments of the inventive concept are also described in the drawings, which are incorporated herein by reference in their entirety.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

### REPRESENTATIVE COMPONENTS

100 Robotic arm assembly
101 Distal portion of the upper arm portion
103 Upper arm portion
105 Proximal portion of the lower arm portion
106 Lower arm portion
110 Computer system
111 User interface
112 Software program
113A Pause switch
113B Kill switch
116 Gantry Robot
120 Operating assembly
122 Actuators
124 Controllers
110 Computer
126 Sensors
127 RFID sensor
129 RFID Reader
132 Elbow joint
134 Wrist joint
136 Shoulder joint
140 Tool assembly
142 Claw tool assembly
144 Gripper
146 Rotational tool assembly
149 Dispenser assembly
150 Base portion
153 Port assembly
155 Rack assembly
160 Rail assembly
160T Transverse rail
160P Parallel rails
165 Autonomous ground vehicle
166 Magnetic floor pathway
170 Smart cage assembly
171 Monitoring cage
172 Port cage
173 Inlet port
174 Door
175 Tunnel
176 Internal cage bottom
177 Sensor array
178A Front cage wall
178B First side cage wall
178C Second side cage wall
178D Back cage wall
179 Internal cage top
180 Optical sensor
182 3D vision system
183 stereo camera system
184 structured light sensor
185 time-of-flight camera
186 force/torque sensor
187 Position sensor
188 Proximity sensor
189 onboard camera
190 Scale
190B Robotic arm scale
191 IR sensor
192 One-way valve
193 Stop
194 RFID Reader

1. A robotic arm assembly and rack assembly comprising:
at least one computer system and software program adapted to operate the robotic arm assembly;
an operating assembly including one or more actuators, controllers, and sensors;
at least an upper arm portion of the robotic arm assembly hingedly coupled to a lower arm portion by an elbow joint, a proximal portion of the lower arm portion hingedly coupled to a wrist joint, a tool assembly hingedly coupled to the wrist joint, and a distal portion of the upper arm portion hingedly coupled to a shoulder joint;
a base portion hingedly coupled to the shoulder joint and hingedly coupled to a port assembly, the port assembly movably coupled to a rail assembly operationally contiguous with a rack assembly;
the rail assembly adapted to guide the robotic arm assembly measurable along Cartesian coordinates x, y, and z of a three-dimensional space containing the rack assembly; and,
a center axis stemming from the port assembly wherein the tool assembly portion is adapted to be directionally vectored within polar coordinates r, θ, and z, wherein the robotic arm assembly is adapted to engage smart cage assemblies disposed on the rack assemblies from a programmed set of operations.

2. The robotic arm assembly and rack assembly of claim 1, wherein engagement with smart cage assemblies is conditional upon receiving sensor data that said engagement will address.

3. The robotic arm assembly of claim 1, wherein engagement with smart cage assemblies is based on a schedule.

4. The robotic arm assembly and rack assembly of claim 1, wherein the tool assembly is a gripper tool assembly.

5. The robotic arm assembly and rack assembly of claim 1 wherein the tool assembly is interchangeable from a group consisting of at least a claw tool assembly, a gripper tool assembly, a dispensing tool assembly, and a rotational tool assembly.

6. The robotic arm assembly and rack assembly of claim 1, wherein at least one optical sensor is disposed on the robotic arm assembly.

7. The robotic arm assembly and rack assembly of claim 1, wherein the robotic arm assembly may at least partially be operated manually by way of a user interface operationally coupled to the computer system.

8. The robotic arm assembly and rack assembly of claim 1, wherein a kill switch is adapted to halt operations before the robotic arm assembly contacts a person.

9. The robotic arm assembly and rack assembly of claim 1, wherein the software program is adapted to learn patterns and make predictions autonomously.

10. The robotic arm assembly and rack assembly of claim 9, wherein data from which patterns are derived includes data generated by sensors within the smart cage assemblies.

11. The robotic arm assembly and rack assembly of claim 1, wherein the robotic arm assembly is adapted, by way of the tool assembly, to connect two or more smart cage assemblies with a tunnel assembly.

12. The robotic arm assembly and rack assembly of claim 1, wherein at least one 3D vision system or an RFID system is disposed on the robotic arm assembly.

13. A robotic arm assembly and rack assembly, comprising:
a rack assembly configured to house a plurality of smart cage assemblies, each smart cage assembly including an external sensor array with sensors for monitoring animal health;
a robotic arm assembly movably coupled to the rack assembly via a rail assembly and gantry, the robotic arm assembly including:
at least one computer system and a software program configured to control the robotic arm assembly;
an operating assembly comprising actuators, controllers, and at least one of a 3D vision system adapted to detecting object positions adapted to estimate positions;
a tool assembly interchangeably equipped with at least one of a claw tool assembly, a gripper tool assembly, a dispenser tool assembly, or a rotational tool assembly, the tool assembly configured to engage the smart cage assemblies for automated maintenance tasks; and
wherein the robotic arm assembly is configured to perform automated maintenance tasks, including cage exchanges, food and water replenishment, and cage enclosure cleaning, based on sensor data from the smart cage assemblies or a predefined schedule, and to connect smart cage assemblies via a mouse inlet port.

14. The robotic arm assembly and rack assembly of claim 13, wherein said automated cage exchanges include robotic arm assembly configured to remove a used smart cage assembly from the rack assembly, connect a clean smart cage assembly to the used smart cage assembly via the mouse inlet port, and use incentives to encourage animal movement to the clean smart cage assembly.

15. The robotic arm assembly and rack assembly of claim 13, wherein the 3D vision system comprises at least one of a stereo camera system, a structured light sensor, and a time-of-flight camera, configured to detect the size, shape, and 3D distance of objects within the rack assembly.

16. The robotic arm assembly and rack assembly of claim 13, further comprising a force/torque sensor disposed on the tool assembly, the force/torque sensor configured to detect the level of force exerted during automated maintenance tasks.

17. The robotic arm assembly and rack assembly of claim 13, wherein the software program includes a machine learning module configured to learn patterns from sensor data observations generated by the smart cage assemblies and predict maintenance needs autonomously.

18. The robotic arm assembly and rack assembly of claim 13, wherein the robotic arm assembly is configured to weigh food or water before replenishment by placing a food container or water bottle on a scale and recording the weight.

19. The robotic arm assembly of claim 13, wherein movement of robotic arm and gantry are adapted by the software program to switch between coordinate systems for navigation and object manipulation based on tasks performed.

20. A robotic arm assembly and rack assembly, comprising:
a rack assembly configured to house a plurality of smart cage assemblies, each smart cage assembly including an external sensor array with sensors for monitoring animal health;
a robotic arm assembly movably coupled to the rack assembly via an autonomous ground vehicle, the robotic arm assembly including:
at least one computer system and a software program configured to control the robotic arm assembly;
an operating assembly comprising actuators, controllers, and at least one of a 3D vision system for detecting object positions;
a tool assembly interchangeably equipped with at least one of a claw tool assembly, a gripper tool assembly, a dispenser tool assembly, or a rotational tool assembly, the tool assembly configured to engage the smart cage assemblies for automated maintenance tasks; and
wherein the robotic arm assembly is configured to perform automated maintenance tasks, including cage exchanges, food and water replenishment, and cage enclosure cleaning, based on sensor data from the smart cage assemblies or a predefined schedule, and to connect smart cage assemblies via a mouse inlet port.
